(19) United States
(12) Patent Application Publication
(10) Pub. No.: US 2026/0278742 A1
(43) Pub. Date: Sep. 17, 2026

(54) MACHINE LEARNING MODEL-BASED IMAGE ENHANCEMENT IN VIDEO SEE-THROUGH (VST) EXTENDED REALITY (XR) DEVICES OR OTHER DEVICES

(71) Applicant: Samsung Electronics Co., Ltd., Suwon-si (KR)

(72) Inventors: Liang Zhao, Sunnyvale, CA (US); Christopher A. Peri, Mountain View, CA (US); Yingen Xiong, Mountain View, CA (US)

(21) Appl. No.: 19/395,184

(22) Filed: Nov. 20, 2025

Related U.S. Application Data
(60) Provisional application No. 63/770,211, filed on Mar. 11, 2025.

(51) Int. Cl. G06T 5/50; G06T 5/60; G06T 5/70; G06T 5/73; G06T 7/33

(52) U.S. Cl. CPC G06T 5/50; G06T 5/60; G06T 5/70; G06T 5/73; G06T 7/337; G06T 2207/20072; G06T 2207/20081; G06T 2207/20084

(57) ABSTRACT

A method includes obtaining a plurality of image frames captured over a period of time and detecting image features in a first image frame of the image frames. The first image frame is captured at an earliest time among the image frames. The method also includes aligning remaining image frames in the image frames to the first image frame by tracking changes in the image features in the remaining image frames. The method further includes providing the aligned remaining image frames to a machine learning model to generate a plurality of enhanced image frames. The machine learning model is trained to employ multi-headed graph attention to modify a target pixel at a specified location in a target image frame based on a weighted sum of other pixels in the image frames. In addition, the method includes initiating presentation of the enhanced image frames on at least one display.

### CROSS-REFERENCE TO RELATED APPLICATION AND PRIORITY CLAIM

This application claims priority under 35 U.S.C. § 119(e) to U.S. Provisional Patent Application No. 63/770,211 filed on Mar. 11, 2025, which is hereby incorporated by reference in its entirety.

### TECHNICAL FIELD

This disclosure relates generally to image enhancement. More specifically, this disclosure relates to machine learning model-based image enhancement in video see-through (VST) extended reality (XR) devices or other devices.

### BACKGROUND

Image enhancement plays a useful or important role in many applications. However, current image processing pipelines used in video see-through (VST) extended reality (XR) devices or other devices can introduce various types of noise. Such noise and its associated deblurring effects can significantly affect user experiences.

### SUMMARY

This disclosure relates to machine learning model-based image enhancement in video see-through (VST) extended reality (XR) devices or other devices.

In a first embodiment, a method includes obtaining, using at least one processing device of an electronic device, a plurality of image frames captured over a period of time. The method also includes detecting, using the at least one processing device, image features in a first image frame of the plurality of image frames, where the first image frame is captured at an earliest time among the plurality of image frames. The method further includes aligning, using the at least one processing device, remaining image frames in the plurality of image frames to the first image frame by tracking changes in the image features in the remaining image frames. The method also includes providing, using the at least one processing device, the aligned remaining image frames to a machine learning model to generate a plurality of enhanced image frames. The machine learning model is trained to employ multi-headed graph attention in order to modify a target pixel at a specified location in a target image frame based on a weighted sum of other pixels in the plurality of image frames. In addition, the method includes initiating, using the at least one processing device, presentation of the enhanced image frames on at least one display.

In a second embodiment, an electronic device includes at least one processing device configured to obtain a plurality of image frames captured over a period of time. The at least one processing device is also configured to detect image features in a first image frame of the plurality of image frames, where the first image frame is captured at an earliest time among the plurality of image frames. The at least one processing device is further configured to align remaining image frames in the plurality of image frames to the first image frame by tracking changes in the image features in the remaining image frames. The at least one processing device is also configured to provide the aligned remaining image frames to a machine learning model to generate a plurality of enhanced image frames. The machine learning model is trained to employ multi-headed graph attention in order to modify a target pixel at a specified location in a target image frame based on a weighted sum of other pixels in the plurality of image frames. In addition, the at least one processing device is configured to initiate presentation of the enhanced image frames on at least one display.

In a third embodiment, a non-transitory machine readable medium contains instructions that when executed cause at least one processor of an electronic device to obtain a plurality of image frames captured over a period of time. The non-transitory machine readable medium also contains instructions that when executed cause the at least one processor to detect image features in a first image frame of the plurality of image frames, where the first image frame is captured at an earliest time among the plurality of image frames. The non-transitory machine readable medium further contains instructions that when executed cause the at least one processor to align remaining image frames in the plurality of image frames to the first image frame by tracking changes in the image features in the remaining image frames. The non-transitory machine readable medium also contains instructions that when executed cause the at least one processor to provide the aligned remaining image frames to a machine learning model to generate a plurality of enhanced image frames. The machine learning model is trained to employ multi-headed graph attention in order to modify a target pixel at a specified location in a target image frame based on a weighted sum of other pixels in the plurality of image frames. In addition, the non-transitory machine readable medium contains instructions that when executed cause the at least one processor to initiate presentation of the enhanced image frames on at least one display.

Any single one or any combination of the following features may be used with the first, second, or third embodiment.

The weighted sum of other pixels in the plurality of image frames may be a weighted sum of at least two of: pixels in neighboring positions of the target pixel in the target image frame; pixels at a same position as the target pixel in one or more image frames before the target image frame; pixels in neighboring positions in one or more image frames before the target image frame; pixels at the same position as the target pixel in one or more image frames following the target image frame; or pixels in neighboring positions in one or more image frames following the target image frame.

The machine learning model may include a convolutional neural network (CNN) encoder, a transformer encoder, and a CNN decoder.

A transformer encoder of the machine learning model may be trained to predict weights to apply to neighboring pixels based on relationships among the neighboring pixels, in addition to a relationship between the target pixel and the neighboring pixels, based on a graph network. The transformer encoder may integrate pixel information over both spatial and temporal neighborhoods of the target pixel within one or more image frames among the plurality of image frames.

The machine learning model may include a graph neural network (GNN) including a number of normalization layers that receive an output of the multi-headed graph attention, with the number of normalization layers corresponding to the graph network.

The image frames may be captured by one or more imaging sensors of a VST XR device. The at least one display may include at least one display of the VST XR device. The machine learning model may be deployed on the VST XR device.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to,” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration that may be employed for machine learning model-based image enhancement in accordance with this disclosure;

FIG. 2 illustrates an example process of machine learning model-based image enhancement in accordance with this disclosure;

FIG. 3 illustrates an example deep image processing system for machine learning model-based image enhancement in accordance with this disclosure;

FIG. 4 illustrates an example pipeline for performing image alignment/stabilization and image enhancement in accordance with this disclosure;

FIGS. 5 and 5A through 5C collectively illustrate an example system for utilizing the deep image processing system of FIG. 3 in accordance with this disclosure;

FIGS. 6 and 6A illustrate an example of spatial and temporal information used for image enhancement by the multi-headed graph attention module in FIG. 5 in accordance with this disclosure;

FIG. 7 illustrates in greater detail an example structure of one variant for a transformer for the system in FIG. 5 in accordance with this disclosure; and

FIG. 8 illustrates example operation of the multi-headed graph attention module in FIG. 5 on pixels of a pixel graph in FIG. 6A in accordance with this disclosure.

### DETAILED DESCRIPTION

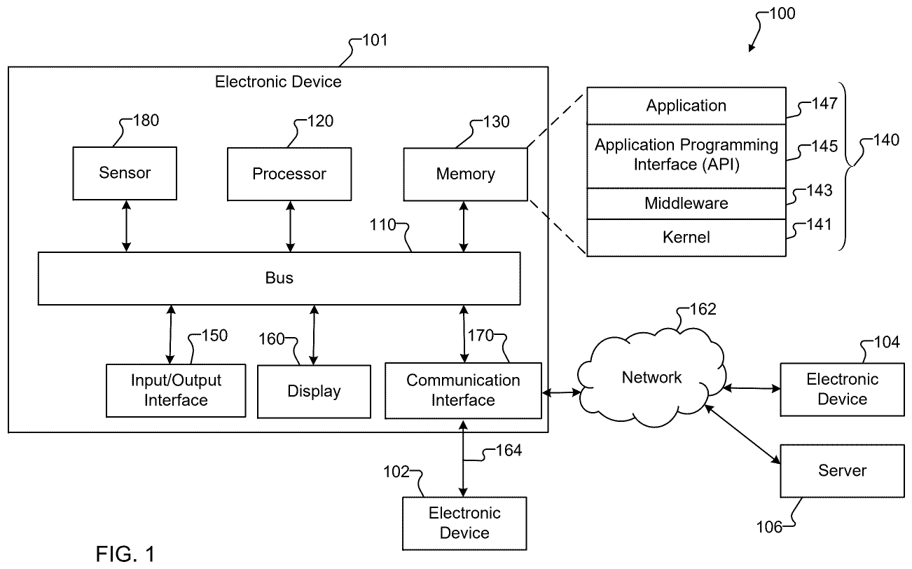

FIGS. 1 through 8, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, image enhancement plays a useful or important role in many applications. However, current image processing pipelines used in video see-through (VST) extended reality (XR) devices or other devices can introduce various types of noise. Such noise and its associated deblurring effects can significantly affect user experiences.

This disclosure provides various techniques for machine learning model-based image enhancement in VST XR devices or other devices. As described in more detail below, multiple image frames can be captured over a period of time, such as by using one or more imaging sensors of a VST XR device. Image features in a first image frame of the multiple image frames can be detected, where the first image frame can be captured at an earliest time among the plurality of image frames. Remaining image frames in the multiple image frames can be aligned to the first image frame, such as by tracking changes in the image features in the remaining image frames. The aligned remaining image frames can be provided to a machine learning model, such as one that includes a convolutional neural network (CNN) encoder, a transformer encoder, and a CNN decoder, to generate multiple enhanced image frames. The machine learning model can be trained to employ multi-headed graph attention in order to modify a target pixel at a specified location in a target image frame based on a weighted sum of other pixels in the plurality of image frames. Presentation of the enhanced image frames on at least one display can be initiated, or the enhanced image frames may be used in other ways.

In this way, the described techniques can (among other things) help to achieve an improved user experience, such as in XR environments, by enhancing image quality. In some cases, a lightweight deep neural network (DNN)-based multi-frame image enhancement model or other machine learning model can be introduced and used for real-time on-device inferencing. The described techniques can also help to overcome different problems associated with conventional DNN-based image enhancement, such as effectively dealing with device movements during image processing and effectively removing image noise/blurring and improving image quality by integrating information from multiple image frames over time.

FIG. 1 illustrates an example network configuration 100 that may be employed for machine learning model-based image enhancement in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described in more detail below, the processor 120 may perform various operations related to machine learning model-based image enhancement.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to machine learning model-based image enhancement. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, Wi-Fi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as a head mounted display (or “HMD”)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network. The electronic device 101 can also be an extended reality (XR) device, which includes a virtual reality (VR) headset or an augmented reality (AR) wearable device, such as eyeglasses that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of the operations (or functions) implemented on the electronic device 101. For example, the server 106 can include a processing module or processor that may support the processor 120 implemented in the electronic device 101. As described in more detail below, the server 106 may perform various operations related to machine learning model-based image enhancement.

Although FIG. 1 illustrates one example of a network configuration 100 that may be employed for machine learning model-based image enhancement, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

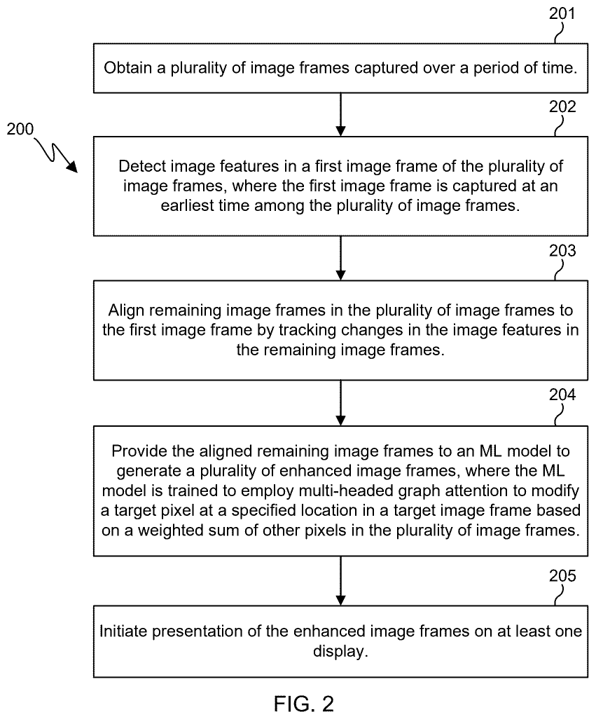

FIG. 2 illustrates an example process 200 of machine learning model-based image enhancement in accordance with this disclosure. For ease of explanation, the process 200 of FIG. 2 is described as being performed using the electronic device 101 in the network configuration 100 of FIG. 1. However, the process 200 may be performed using any other suitable device(s) (such as the server 106) and in any other suitable system(s).

As shown in FIG. 2, the process 200 begins with obtaining a plurality of image frames captured over a period of time (step 201). For example, the plurality of image frames may be captured by one or more imaging sensors 180 of a VST XR device or other electronic device 101. The plurality of image frames can contain spatial and temporal context information for pixel modification. Image features in a first image frame of the plurality of image frames are detected (step 202). The first image frame can be captured at an earliest time among the plurality of image frames. Remaining image frames in the plurality of image frames are aligned to the first image frame, such as by tracking changes in the image features in the remaining image frames (step 203). The image features may include, for example, edges of objects within the image frames. As a particular example, human head movement across the plurality of image frames can correspond to image features to be tracked across the image frames.

The aligned remaining image frames are provided to a machine learning model to generate a plurality of enhanced image frames (step 204). The machine learning model can be trained to employ multi-headed graph attention in order to modify a target pixel at a specified location in a target image frame based on a weighted sum of other pixels in the plurality of image frames. The weighted sum of other pixels in the plurality of image frames used to modify the target pixel may be a weighted sum of at least two of: pixels in neighboring positions of the target pixel in the target image frame; pixels at a same position as the target pixel in one or more image frames before the target image frame; pixels in neighboring positions in one or more image frames before the target image frame; pixels at the same position as the target pixel in one or more image frames following the target image frame; or pixels in neighboring positions in one or more image frames following the target image frame. In some cases, the machine learning model may include a convolutional neural network (CNN) encoder, a transformer encoder, and a CNN decoder. Also, in some cases, a transformer encoder of the machine learning model may be trained to predict weights to apply to neighboring pixels when modifying the target pixel based on relationships among the neighboring pixels, in addition to a relationship between the target pixel and the neighboring pixels, based on a graph network. For example, the transformer encoder could integrate pixel information over both spatial and temporal neighborhoods of the target pixel within one or more image frames among the plurality of image frames. In some embodiments, the machine learning model can be deployed on the VST XR device or other electronic device 101 that includes the one or more imaging sensors 180 used to capture the image frames.

Presentation of the enhanced image frames on at least one display is initiated (step 205). In some cases, the at least one display may be part of the VST XR device or other electronic device 101 including the one or more imaging sensors 180 used to capture the image frames. Thus, for instance, the at least one display could include the display(s) 160 of the electronic device 101. Here, the image frames can be enhanced by removal of image noise/blurring and by other image quality improvements resulting from integrating pixel information from multiple image frames over time.

Although FIG. 2 illustrates one example of a process 200 of machine learning model-based image enhancement, various changes may be made to FIG. 2. For example, while shown as a series of steps, various steps in FIG. 2 could overlap, occur in parallel, occur in a different order, or occur any number of times (including zero times).

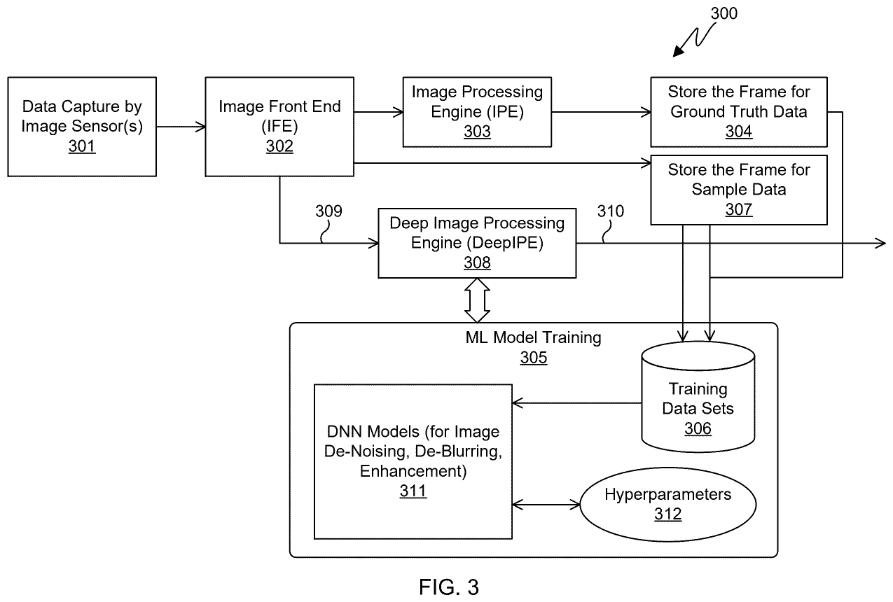

FIG. 3 illustrates an example deep image processing system 300 for machine learning model-based image enhancement in accordance with this disclosure. For ease of explanation, the deep image processing system 300 of FIG. 3 is described as being implemented within the electronic device 101 in the network configuration 100 of FIG. 1, which can be configured to perform the process 200 of FIG. 2. However, the deep image processing system 300 may be implemented using any other suitable device(s) and in any other suitable system(s) and process(es).

One goal for the deep image processing system 300 could be to generate quality-improved image frames for a VST XR pipeline or other image processing pipeline with low latency using one or more machine learning models. As shown in FIG. 3, the deep image processing system 300 includes data capture by one or more image sensors 301 (which could represent one or more imaging sensors 180 of the electronic device 101), which generate image frames that can be processed by an image front end 302. The image front end 302 may perform various pre-processing functions or other functions as needed or desired, such as identification and correction of bad individual pixels, white balance adjustment, etc. The image frames output by the image front end 302 are made available to an image processing engine 303, which can be applied to process captured image frames to be saved as ground truth data 304 for machine learning (ML) model training 305. For instance, the ground truth data 304 can form part of one or more training datasets 306. Raw image frames or other image frames from the image front end 302 can also be saved as sample data 307 for the ML model training 305. Again, the sample data 307 can form part of the one or more training datasets 306.

The one or more training datasets 306 can be created with the ground truth data 304 and the sample data 307. In the ML model training 305, one or more DNN or other machine learning models 311 can be trained to perform image denoising, deblurring, and other enhancements with the training dataset(s) 306. Among other things, the training dataset(s) 306 can allow the machine learning model(s) 311 to learn relationships between the sample images and the ground truth data and save those relationships as hyperparameters 312 (weights) used by the machine learning model(s) 311. For example, these weights can be used by the machine learning model(s) 311 to perform pixel modifications based on spatial and temporal context information.

In this example, image frame data from the image front end 302, such as full-resolution image frames 309, can be processed with one or more trained machine learning models 311 in a deep image processing engine 308 to obtain quality-improved image frames, such as low-latency image frames 310, to meet various requirements of a VST XR pipeline or other image processing pipeline. For example, the processed frames 310 from the deep image processing engine 308 could be passed to one or more passthrough transformations in a VST XR pipeline. In some cases, the machine learning models 311 may include one or more models for image denoising, deblurring, or other enhancements, as well as one or more other models. The machine learning models 311 can operate based on, and may update, their hyperparameters 312.

Although FIG. 3 illustrates one example of a deep image processing system 300 for machine learning model-based image enhancement, various changes may be made to FIG. 3. For example, storing the output of the image processing engine 303 as the ground truth data 304 in the training dataset(s) 306 and storing the output of the image front end 302 as the sample data 307 in the training dataset(s) 306 are shown as separate processes. However, these two processes may be integrated into a single continuous process, may each be subdivided into component process(es), or may have other process(es) interspersed therein or therebetween. Also, FIG. 3 shows both training of the machine learning model(s) 311 and use of the machine learning model(s) 311 for inferencing in the same device or system. However, one device or system (such as the server 106) could train the machine learning model(s) 311, and another device or system (such as the electronic device 101) could use the machine learning model(s) 311.

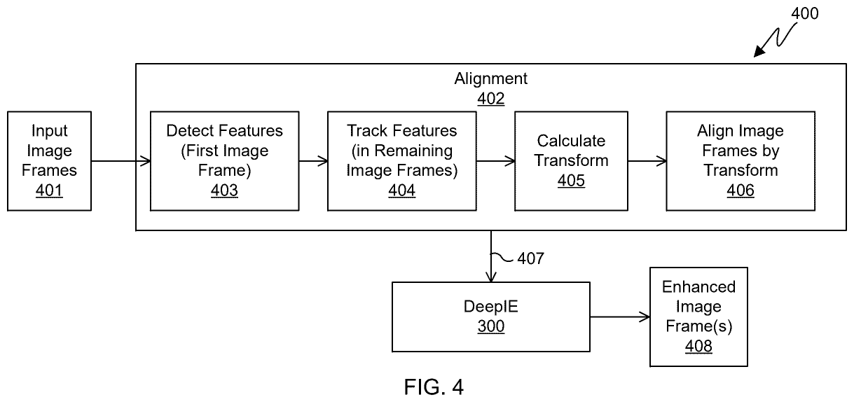

FIG. 4 illustrates an example pipeline 400 for performing image alignment/stabilization and image enhancement in accordance with this disclosure. For ease of explanation, the pipeline 400 of FIG. 4 is described as being implemented within the electronic device 101 in the network configuration 100 of FIG. 1, which can be configured to perform the process 200 of FIG. 2. However, the pipeline 400 may be implemented using any other suitable device(s) and in any other suitable system(s) and process(es).

As shown in FIG. 4, the pipeline 400 performs image alignment and stabilization and image enhancement using the deep image processing system 300. Here, the pipeline 400 receives input image frames 401 at an alignment/stabilization module 402. The inputs to the alignment/stabilization module 402 are a sequence of captured image frames from the image sensor(s) 301 and made available via the image front end 302. A detection function 403 generally operates to detect features in the first image frame 401, and a tracking function 404 generally operates to track those features in remaining image frames 401. A calculation function 405 generally operates to identify at least one transformation based on the tracked features, where the transformation(s) can identify how to warp or otherwise modify at least some of the image frames 401 so that the identified features are generally aligned. An alignment function 406 generally operates to apply the transformation(s) in order to warp at least some of the image frames 401 and align the contents of the image frames. Here, the deep image processing system 300 can take the aligned image frames 407 as input and output enhanced image frames 408 as described in further detail below.

Although FIG. 4 illustrates one example of a pipeline 400 for performing image alignment/stabilization and image enhancement, various changes may be made to FIG. 4. For example, various functions shown here could be performed serially or in parallel, and additional functions could be added.

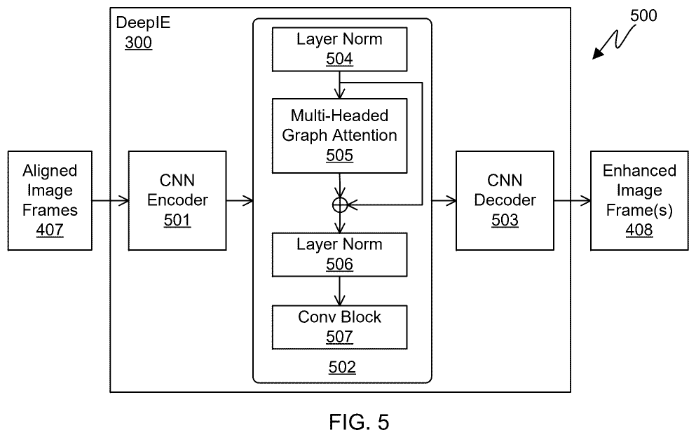

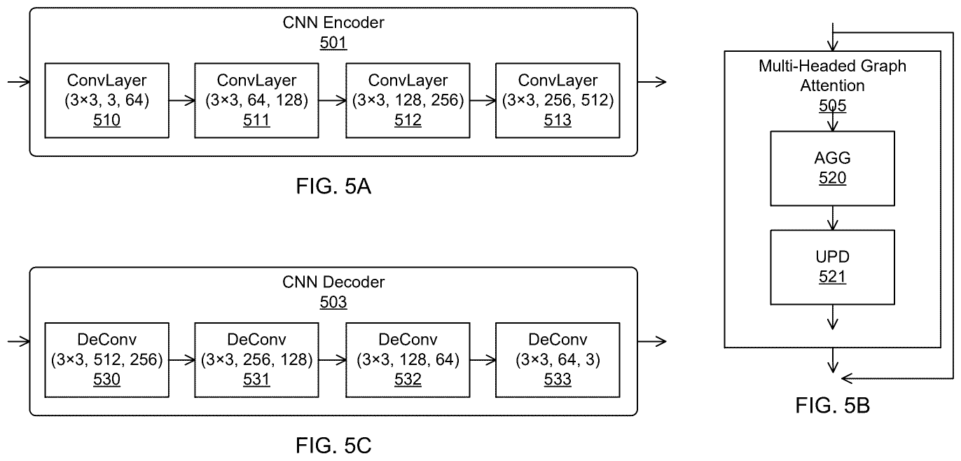

FIGS. 5 and 5A through 5C collectively illustrate an example system 500 for utilizing the deep image processing system 300 of FIG. 3 in accordance with this disclosure. For ease of explanation, the system 500 of FIGS. 5 and 5A through 5C is described as being implemented within the deep image processing engine 308 of FIG. 3 and as part of the pipeline 400 of FIG. 4, where the pipeline 400 of FIG. 4 is implemented using the electronic device 101 in the network configuration 100 of FIG. 1 (which can be configured to perform the process 200 of FIG. 2). However, the system 500 may be implemented using any other suitable device(s) and pipeline(s) and in any other suitable system(s) and process(es).

As shown in FIG. 5, the system 500 includes a convolutional neural network (CNN) encoder 501, a transformer 502, and a CNN decoder 503. In some cases, these modules can be integrated for end-to-end training and inferencing, such as when implemented as at least part of the machine learning model(s) 311 that are interfaced with the deep image processing engine 308.

In this example, given aligned image frames 407 from the alignment/stabilization module 402, the CNN encoder 501 extracts low-level image features, and the transformer 502 extracts spatial and temporal contextual features from the aligned image frames 407. Within the transformer 502, the spatial and temporal contextual features can be normalized via layer normalization 504, the output of which can be passed to a multi-headed graph attention module 505. The multi-headed graph attention module 505 can be used to calculate weights of spatial-temporal attention, such as via a graph neural network (GNN), for processing graph-structured data.

Normalized CNN spatial and temporal contextual features output by the layer normalization 504 and the output of the multi-headed graph attention module 505 can be combined and further normalized by layer normalization 506. Spatial and temporal contextual features output by the layer normalization 506 can be extracted by a convolutional block 507. Finally, the CNN decoder 503 can reconstruct one or more enhanced image frames 408 from the extracted and normalized spatial and temporal contextual features. The enhanced image frame(s) 408 can be output from the deep image processing system 300.

FIG. 5A depicts in greater detail a portion of an example structure of the CNN encoder 501 in FIG. 5. The CNN encoder 501 here can capture localized features like edges and textures and perform a sequence of convolution operations for extracting local image features. In the example shown, the CNN encoder 501 includes a first convolutional layer 510 (which could have a kernel with spatial dimensions of 3×3, 3 inputs, and 64 outputs), a second convolutional layer 511 (which could have a kernel with spatial dimensions of 3×3, 64 inputs, and 128 outputs); a third convolutional layer 512 (which could have a kernel with spatial dimensions of 3×3, 128 inputs, and 256 outputs), and a fourth convolutional layer 513 (which could have a kernel with spatial dimensions of 3×3, 256 inputs, and 512 outputs). Note, however, that the numbers of dimensions, numbers of inputs, and numbers of outputs could vary as needed or desired.

FIG. 5B depicts in greater detail a portion of an example structure of the multi-headed graph attention module 505 in FIG. 5. The multi-headed graph attention module 505 here includes an aggregation (AGG) function 520, which generally operates to aggregate neighborhoods of pixels. The multi-headed graph attention module 505 also includes an update (UPD) function 521, which generally operates to update the representation for each target pixel based on the associated output of the aggregation function 520 (meaning the representation for each target pixel can be updated based on the associated neighborhood of pixels). The multi-headed graph attention module 505 can make predictions based on the final representations for the pixels within the image frames. For context-level attention, the input could be normalized first, and the multi-headed graph attention module 505 can extract spatial/temporal context information, with self and temporal context information subsequently combined and normalized.

FIG. 5C depicts in greater detail a portion of an example structure of the CNN decoder 503 in FIG. 5. The CNN decoder 503 here can involve a sequence of deconvolution operations for recovering enhanced image frames. In the example shown, the CNN decoder 503 includes a first deconvolution layer 530 (which could have a kernel with spatial dimensions of 3×3, 512 inputs, and 256 outputs), a second deconvolution layer 531 (which could have a kernel with spatial dimensions of 3×3, 256 inputs, and 128 outputs), a third deconvolution layer 532 (which could have a kernel with spatial dimensions of 3×3, 128 inputs, and 64 outputs), and a fourth deconvolution layer 533 (which could have a kernel with spatial dimensions of 3×3, 64 inputs, and 3 outputs). Note, however, that the numbers of dimensions, numbers of inputs, and numbers of outputs could vary as needed or desired.

Although FIGS. 5 and 5A through 5C collectively illustrate one example of a system 500 for utilizing the deep image processing system 300 of FIG. 3, various changes may be made to FIGS. 5 and 5A through 5C. For example, while a single pipeline is illustrated, multiple pipelines may be arranged to operate in parallel on each image frame or a set of image frames. Also, other functional modules may be included in each of the CNN encoder 501, the multi-headed graph attention module 505, and the CNN decoder 503.

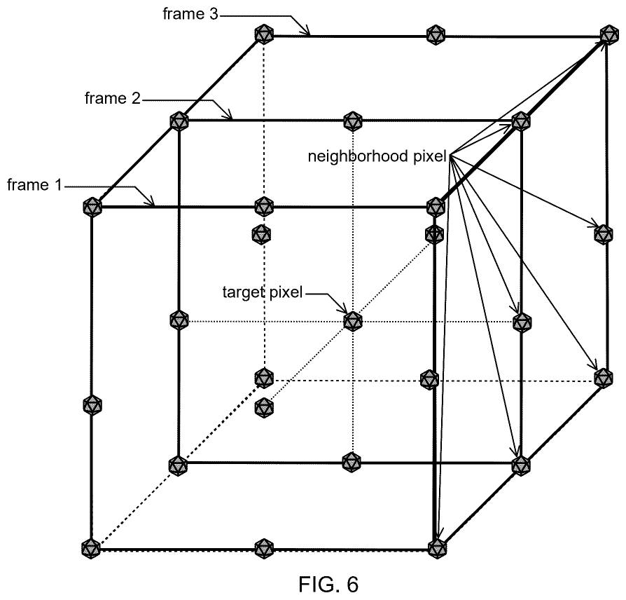

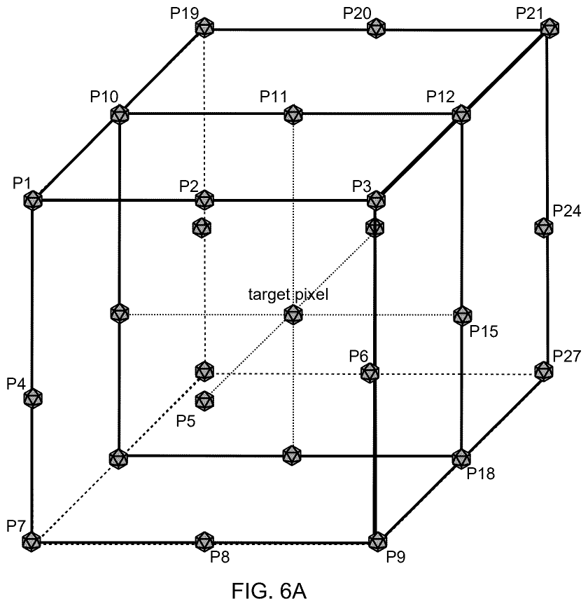

Note that the multi-headed graph attention module 505 here can extract information from spatial and temporal neighbors, performing image enhancement by integrating pixel information over both spatial and temporal neighborhoods (such as across several image frames). FIGS. 6 and 6A illustrate an example of spatial and temporal information used for image enhancement by the multi-headed graph attention module 505 in FIG. 5 in accordance with this disclosure. As shown in FIG. 6, a target pixel is located at the center of a 3×3 set or other set of pixels from one frame (“frame 2” in this example) among a set of consecutive frames (“frame 1,” “frame 2,” and “frame 3” in this example). The remaining pixels within the set of frames are neighborhood pixels. As shown in FIG. 6A, all of the pixels may be labeled P1 through P27, with pixels P1 through P9 in frame 1, P10 through P18 in frame 2, and pixels P19 through P27 in frame 3.

Although FIGS. 6 and 6A illustrate one example of spatial and temporal information used for image enhancement by the multi-headed graph attention module 505 in FIG. 5, various changes may be made to FIGS. 6 and 6A. For example, the number of pixels and the arrangement of pixels representing a neighborhood of pixels could vary.

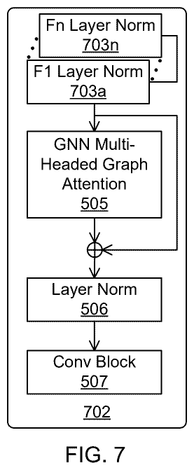

FIG. 7 illustrates in greater detail an example structure of one variant for a transformer 702 for the system 500 in FIG. 5 in accordance with this disclosure. Here, a DNN or other machine learning model can combine CNN spatial features (from one image frame) and CNN temporal features (from multiple frames) for better image enhancement via a newly-introduced spatial-temporal integration module.

For spatial/temporal-based image enhancement, a recovered value at each pixel can represent a weighted sum of neighborhood pixels, both spatially and temporally. Determining the contribution/weight from each neighbor independently could be sub-optimal and may not take into account statistics among neighbors. The multi-headed graph attention module 505 described above can represent a GNN-based or other ML-based approach for learning to predict the weights of each neighbor pixel, spatially and temporally, which takes the relation among the neighbors into consideration. As shown in FIG. 7, the multi-headed graph attention module 505 can predict the weights of each neighbor pixel both spatially and temporally utilizing layer normalization for each frame (that is, F1 layer normalization 703a for frame 1 through Fn layer normalization 703n for frame n). Separate layer normalization for each frame allows spatial information within a frame to be determined.

Although FIG. 7 illustrates in greater detail one example of a structure of one variant for a transformer 702 for the system 500 in FIG. 5, various changes may be made to FIG. 7. For example, there may be any suitable number of layer normalizations, depending on the number of image frames.

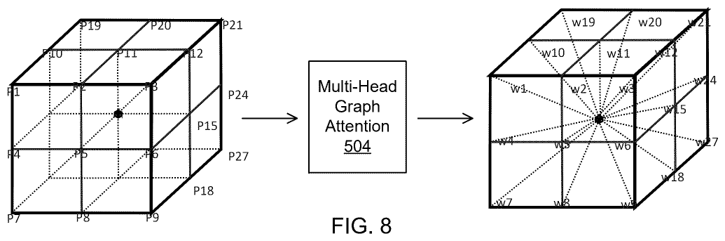

FIG. 8 illustrates example operation of the multi-headed graph attention module 505 in FIG. 5 on pixels of the pixel graph in FIG. 6A in accordance with this disclosure. In this example, the multi-headed graph attention module 505 employs the pixel graph as an input and determines attention weights w1 through w27 for corresponding pixels as indicated at the output shown in FIG. 8 for the multi-headed graph attention module 505. For example, an attention weight can be determined for a target pixel relative to each neighborhood pixel. In the pixel graph of FIG. 6A, this could include an attention weight w1 for pixel P1, an attention weight w2 for pixel P2, an attention weight w3 for pixel P3, and so on. In this way, both spatial and temporal context information can be employed for image enhancement by the multi-headed graph attention module 505.

In some embodiments, a loss function implemented for the transformer 502 or 702 may be a weighted sum of pixel-level loss and image level loss. In some cases, this loss could be expressed as follows.

$$L ( x ) = {w}_{pixel} {L}_{pixel} ( x ) + {w}_{image} {L}_{image} ( x ) ,$$

Here, wₚᵢₓₑₗ and w_{image} are weights for Lₚᵢₓₑₗ(x) and L_{image}(x), respectively.

Various permutations of neighborhood pixels may be employed for the loss function used in modifying a target pixel within a target frame. For example, in the case of the pixel graph of FIG. 6A, for each image frame (frame 1, frame 2, and frame 3) in FIG. 6, the target pixel may be modified based on a weighted sum of other pixels in frame 1, frame 2, and frame 3. The other pixels used for the weighted sum may include at least two of: pixels P10 through P18 in neighboring positions of the target pixel in the target image frame (frame 2); pixel P5 at a same position as the target pixel in the image frame (frame 1) before the target image frame; one or more of pixels P1 through P9 in neighboring positions in the image frame (frame 1) before the target image frame; pixel P23 (not labeled in FIG. 6A for clarity) at the same position as the target pixel in the image frame (frame 3) following the target image frame; and/or pixels P19 through P27 (where pixels P22, P23, P25, and P26 are not labeled in FIG. 6A for clarity) in neighboring positions in the image frame (frame 3) following the target image frame.

For graph attention, the input can be normalized, such as via one or more layer normalizations, and multi-headed graph (GNN) attention can extract spatial/temporal context information. This can be followed by a combination of the self and spatial/temporal context information. The result can be normalized, and a sequence of convolution operations can be performed.

In contrast with scaled dot-product attention image enhancement, the multi-headed graph (GNN) attention of the present disclosure employs a machine learning model that combines local/spatial CNN features (from one image frame alone) and context/temporal features (from multiple sequential image frames) for better image enhancement. For spatial/temporal-based image enhancement, a recovered value at each pixel can be a weighted sum of neighboring pixels, spatially and temporally. Unlike approaches that determine a contribution/weight from each neighbor independently (which can be sub-optimal and not take into account the statistics among neighbors), the present disclosure introduces a multi-headed graph attention mechanism for learning to predict the weights of each neighbor pixel spatially and temporally, taking the relations among the neighbors into consideration.

Although FIG. 8 illustrates one example of operation of the multi-headed graph attention module 505 in FIG. 5 on pixels of the pixel graph in FIG. 6A, various changes may be made to FIG. 8. For example, the pixel graph here is for illustration and explanation only. The number of pixels in the pixel graph and the arrangement of the pixels in the pixel graph could vary as needed or desired.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompasses such changes and modifications as fall within the scope of the appended claims.

What is claimed is:

1. A method comprising:
obtaining, using at least one processing device of an electronic device, a plurality of image frames captured over a period of time;
detecting, using the at least one processing device, image features in a first image frame of the plurality of image frames, wherein the first image frame is captured at an earliest time among the plurality of image frames;
aligning, using the at least one processing device, remaining image frames in the plurality of image frames to the first image frame by tracking changes in the image features in the remaining image frames;
providing, using the at least one processing device, the aligned remaining image frames to a machine learning model to generate a plurality of enhanced image frames, wherein the machine learning model is trained to employ a multi-headed graph attention in order to modify a target pixel at a specified location in a target image frame based on a weighted sum of other pixels in the plurality of image frames; and
initiating, using the at least one processing device, presentation of the enhanced image frames on at least one display.

2. The method of claim 1, wherein the weighted sum of other pixels in the plurality of image frames is a weighted sum of at least two of:
pixels in neighboring positions of the target pixel in the target image frame;
pixels at a same position as the target pixel in one or more image frames before the target image frame;
pixels in neighboring positions in one or more image frames before the target image frame;
pixels at the same position as the target pixel in one or more image frames following the target image frame; or
pixels in neighboring positions in one or more image frames following the target image frame.

3. The method of claim 1, wherein the machine learning model comprises a convolutional neural network (CNN) encoder, a transformer encoder, and a CNN decoder.

4. The method of claim 1, wherein a transformer encoder of the machine learning model is trained to predict weights to apply to neighboring pixels based on relationships among the neighboring pixels, in addition to a relationship between the target pixel and the neighboring pixels, based on a graph network.

5. The method of claim 4, wherein the transformer encoder integrates pixel information over both spatial and temporal neighborhoods of the target pixel within one or more image frames among the plurality of image frames.

6. The method of claim 5, wherein:
the machine learning model comprises a graph neural network (GNN) including a number of normalization layers that receive an output of the multi-headed graph attention; and
the number of normalization layers corresponds to the graph network.

7. The method of claim 1, wherein:
the image frames are captured by one or more imaging sensors of a video see-through (VST) extended reality (XR) device; and
the at least one display comprises at least one display of the VST XR device.

8. The method of claim 7, wherein the machine learning model is deployed on the VST XR device.

9. An electronic device comprising:
at least one processing device configured to:
obtain a plurality of image frames captured over a period of time;
detect image features in a first image frame of the plurality of image frames, wherein the first image frame is captured at an earliest time among the plurality of image frames;
align remaining image frames in the plurality of image frames to the first image frame by tracking changes in the image features in the remaining image frames;
provide the aligned remaining image frames to a machine learning model to generate a plurality of enhanced image frames, wherein the machine learning model is trained to employ a multi-headed graph attention in order to modify a target pixel at a specified location in a target image frame based on a weighted sum of other pixels in the plurality of image frames; and
initiate presentation of the enhanced image frames on at least one display.

10. The electronic device of claim 9, wherein the weighted sum of other pixels in the plurality of image frames is a weighted sum of at least two of:
pixels in neighboring positions of the target pixel in the target image frame;
pixels at a same position as the target pixel in one or more image frames before the target image frame;
pixels in neighboring positions in one or more image frames before the target image frame;
pixels at the same position as the target pixel in one or more image frames following the target image frame; or
pixels in neighboring positions in one or more image frames following the target image frame.

11. The electronic device of claim 9, wherein the machine learning model comprises a convolutional neural network (CNN) encoder, a transformer encoder, and a CNN decoder.

12. The electronic device of claim 9, wherein a transformer encoder of the machine learning model is trained to predict weights to apply to neighboring pixels based on relationships among the neighboring pixels, in addition to a relationship between the target pixel and the neighboring pixels, based on a graph network.

13. The electronic device of claim 12, wherein the transformer encoder is configured to integrate pixel information over both spatial and temporal neighborhoods of the target pixel within one or more image frames among the plurality of image frames.

14. The electronic device of claim 13, wherein:
the machine learning model comprises a graph neural network (GNN) including a number of normalization layers configured to receive an output of the multi-headed graph attention; and
the number of normalization layers corresponds to the graph network.

15. The electronic device of claim 9, wherein:
the electronic device comprises a video see-through (VST) extended reality (XR) device;
the at least one display comprises at least one display of the VST XR device; and
the VST XR device further comprises one or more imaging sensors configured to capture the image frames.

16. The electronic device of claim 15, wherein the machine learning model is deployed on the VST XR device.

17. A non-transitory machine readable medium containing instructions that when executed cause at least one processor of an electronic device to:
obtain a plurality of image frames captured over a period of time;
detect image features in a first image frame of the plurality of image frames, wherein the first image frame is captured at an earliest time among the plurality of image frames;
align remaining image frames in the plurality of image frames to the first image frame by tracking changes in the image features in the remaining image frames;
provide the aligned remaining image frames to a machine learning model to generate a plurality of enhanced image frames, wherein the machine learning model is trained to employ a multi-headed graph attention in order to modify a target pixel at a specified location in a target image frame based on a weighted sum of other pixels in the plurality of image frames; and
initiate presentation of the enhanced image frames on at least one display.

18. The non-transitory machine readable medium of claim 17, wherein the weighted sum of other pixels in the plurality of image frames is a weighted sum of at least two of:
pixels in neighboring positions of the target pixel in the target image frame;
pixels at a same position as the target pixel in one or more image frames before the target image frame;
pixels in neighboring positions in one or more image frames before the target image frame;
pixels at the same position as the target pixel in one or more image frames following the target image frame; or
pixels in neighboring positions in one or more image frames following the target image frame.

19. The non-transitory machine readable medium of claim 17, wherein the machine learning model comprises a convolutional neural network (CNN) encoder, a transformer encoder, and a CNN decoder.

20. The non-transitory machine readable medium of claim 17, wherein a transformer encoder of the machine learning model is trained to predict weights to apply to neighboring pixels based on relationships among the neighboring pixels, in addition to a relationship between the target pixel and the neighboring pixels based on a graph network.
